(19) United States
(12) Patent Application Publication
(10) Pub. No.: US 2003/0120543 A1
(43) Pub. Date: Jun. 26, 2003

(54) System, method, and product for use in supplying information via the internet

(76) Inventor: Matthew S. Carey, Glen Ridge, NJ (US)

Correspondence Address: Cummings & Lockwood, Granite Square, 700 State Street, P.O. Box 1960, New Haven, CT, 06509-1960, US

(21) Appl. No.: 10/290,100

(22) Filed: Nov. 6, 2002

Related U.S. Application Data
(60) Provisional application No. 60/338,005, filed on Nov. 6, 2001.

(51) Int. Cl. G06F 17/60; G06F 15/16

(52) U.S. Cl. 705/14; 709/203

(57) ABSTRACT

A message provided by a non-internet media source includes a URL having a modified prefix, a domain, and a suffix. A method for use in supplying information via the internet includes receiving a request having the URL specified in the message. One or more processing steps may be performed in response to receiving the request. Another method for use in supplying information via the internet includes receiving a request for information at a first server associated with a first domain, and redirecting to a server for another domain if the request has a URL having a modified prefix.

### CROSS-REFERENCE TO RELATED APPLICATION

This patent application claims the benefit under 35 U.S.C. 119(e) of U.S. Provisional Application Serial No. 60/338,005, filed Nov. 6, 2001, entitled “Intermediary Frame-Based Marketing Technique”, which is hereby expressly incorporated by reference as part of the present disclosure.

### TECHNICAL FIELD

The present invention relates to systems, methods, and products for use in supplying information via the Internet.

### RELATED INFORMATION

Today, in order for a reader of a magazine, or a viewer of a television program to respond to advertising or editorial content provided in those media, there are a variety of communication mechanisms that can be employed. Going to a location, mail, email, phone, fax, and the Internet all constitute alternatives for a consumer to respond to that content, or disseminated information. A persistent problem for publishers and broadcasters alike is that tracking such response activity, and assigning it to specific content or disseminated material is difficult. In each case, the challenge is getting the respondent to tell the content supplier what content, if any, produced the response. With Internet responses to Internet material, this difficulty is eliminated when responses are channeled through hyperlink buttons. However, with Internet responses to non-Internet material, this difficulty is increased due to the fact that the respondent usually has substantial access to online information, with no obligation to tell the content supplier anything. While it is possible to query anonymous web visitors using forms and restricted content, this is an inefficient means of getting information as it often turns the respondent toward alternative information sources before the restricted information is provided, or the form completed.

Some of the prevailing means of tracking and managing response information are generic to specific media segments. For example, non-internet business and mass media have a vested interest in response tracking. Business publications use an inquiry qualification system known as Reader Service to substantiate reader impact for the advertiser, as well as for its editorial product. Reader Service delivers tangible responses to advertising and editorial through the use of a mail-in Business Reply Card, known as a “Bingo” card, bound into publications. Readers use this card to inquire about specific editorial or advertising content within the specific issue where it is published. While these systems remain in widespread use today, the Internet has now become the primary way to respond to content in business publications. This has resulted in a dramatic reduction in magazine Reader Service inquiry “pull” numbers over the past decade and a general decline in its importance to publishers and advertisers alike. No comparable technique has replaced Reader Service, and the ability to track and record inquiry activity to business publication content has been reduced. With mass media, consumer advertising accountability and editorial quality control depends on a variety of ratings systems that consist of ongoing research sampling of selected demographics. For direct response tracking, where required, content providers use a variety of techniques such as toll-free phone lines, coded verbal lines (“tell 'em Larry sent you . . . ”), and post-promotion research. As with business media, with the advent of the Internet, mass market web sites are an increasingly common component of a content provider's call to action. This puts the tracking responsibility onto content delivery systems on the content provider's web site. Content delivery systems (FIG. 1—see description in the section below) compare the visitor's past sessions on the site with other known data about the visitor (IP address, for example, and personally identifiable information which may be available for rental or purchase in the market). This common practice works well for frequent site visitors, but for new visitors, or for frequent visitors expressing a new interest, the content delivery system needs to make numerous internal data comparisons before it can determine what content is most appropriate to deliver. And, even this content delivery represents an estimation based on aggregated information.

As opposed to traditional Media, online content providers enjoy a closed system with respect to content delivery and reader response. Material is published together with direct response mechanisms such as link buttons and hyperlinks that provide the means for the reader to respond. Self-contained within the parameters of the response hyperlink are instructions that direct the visitor to specified material, and which also is in a position to alert the delivery system that is supplying that material of what material, and what location immediately preceded this delivery command. This internal machine communication can take various forms, but the state-of-the-art of the online content provider's capability lies in the concept of Automated Content Delivery. FIG. 1 is a representation of a typical content delivery system that employs a public network such as the Internet 20, where content is supplied to terminal 21 via a web server (ISP). The content provided to the terminal is provided by the ISP based on an address (URL, or universal resource locator) supplied by the operator of the terminal either at the click of a hyperlink button, or by an entry into the address line of an Internet browser. A content server 23 then provides content to the ISP. This content is distributed either from the content server's own memory, or from other content servers 24. This content is supplied on the basis of the URL, which causes the ISP to request content, and the content server to deliver it via a content delivery database 25 stored on, or connected to the content host server. That content access is then provided to the terminal operator via the ISP. This transaction permits the content server 23 to store in memory all elements of the transaction, together with a numeric identifier that is unique to the terminal that is being operated (IP Address). This stored data provides the content server with a benchmark for subsequent requests from the same computer, as identified by the IP address. This benchmark enables the content server to compare subsequent requests by the operator of that terminal with those earlier requests stored in memory. As these benchmarks accumulate over repeated visits, certain inferences may be drawn about the particular interests, and other characteristics of the visitor based on a variety of statistical comparisons that occur on a tracking database 26. Content that is provided to the identified terminal in these subsequent visits reflects these comparisons as they relate to the specific requests being made by the terminal operator in that subsequent session, and can be “tailored” accordingly, so long as the data is sufficient to perform such an operation.

Most non-Internet content providers enjoy access to or ownership of online assets that include some level of automatic content delivery, as described above. This provides them with the means to acquire information about traffic that their non-Internet properties generate online. This information depends on a procedure that matches the data provided to the Content Server 23 by the Content Database 25 and the Tracking Database 26. This process queries the tracking database for records that show how the content database was accessed previously by the respondent, and compares them with records that show how the content is currently being accessed by the respondent. Assuming the respondent did request data previously from the system, this information can provide a meaningful pattern about that respondent's interests. At worst, it may only provide ambiguous data that require more online activity by the respondent to create such a pattern. At best, the system causes specific content to be delivered under the control of the content provider to the respondent during a session. This process continues to depend upon on-site activity, and must be able to identify patterns before it can successfully operate. With automated content delivery, identifying and relating particular respondents to particular non-Internet material can only be achieved over repeated visits, and relies upon statistical inferences drawn from those visits.

Other Response Tracking Methods include such things as including email addresses as response mechanisms into published material, or providing specific “pages” for respondents to link to that are tailored to indicate where the advertiser's inquiry has been generated, and to provide instant, relevant content. This tailored page consists of a simple path extension (/path) at the end of the URL. While this extension is useful to visitors, and content providers alike, the path information can become lengthy and complex. In the case where content is provided directly by a database, that path must include the same kinds of query statements as already discussed. In addition, the path statement must deliver the respondent to a specific page. This means that using the path statement to determine the response to a given piece of content requires that a matching page be produced for every piece of content to be assessed. This becomes impractical across the wide range of content that is produced by the Media in general.

As a result of the limitations of prevailing response tracking techniques and mechanisms, improved methods for connecting readers/viewers/listeners directly to web content, and/or for quantifying and qualifying activity that results from that connection, would be desirable.

### SUMMARY OF THE INVENTION

According to one aspect of the present invention, a method for use in supplying information sought in response to a message provided by a non-internet media source, the method comprising: receiving a request for information from a requestor via the internet, the request having a URL including a modified prefix, a domain, and a suffix specified in the message provided by a non-internet media source.

According to another aspect of the present invention, a method for use in supplying information sought in response to a message provided by a non-internet media source, the method comprising: receiving a request for information from a requester via the internet; and performing a processing step conditioned on the request having a URL including a modified prefix, a domain, and a suffix specified in the message provided by a non-internet media source.

According to another aspect of the present invention, a method for use in supplying information sought by a consumer of goods or services in response to a message provided by a non-internet media source in regard to a supplier or goods or services, the method comprising: specifying a predetermined URL to be included in the message to be provided by the non-internet media source, the predetermined URL having a modified prefix, a domain, and a suffix; and servicing a request for information regarding the supplier or goods or services supplied by the supplier, through a website that is associated with the predetermined URL.

According to another aspect of the present invention, a system for use in supplying information sought in response to a message provided by a non-internet media source, the system comprising: a server for receiving a request for information from a requestor via the internet, and for performing a processing step conditioned on the request having a URL including a modified prefix, a domain, and a suffix specified in the message provided by a non-internet media source.

According to another aspect of the present invention, a system for use in supplying information sought in response to a message provided by a non-internet media source, the system comprising: a server for receiving a request for information from a requestor via the internet, the server including means for performing a processing step conditioned on the request having a URL including a modified prefix, a domain, and a suffix specified in the message provided by a non-internet media source.

According to another aspect of the present invention, a system for use in responding to a request for information, the system comprising: a server, associated with a domain, for receiving a request for information, and for redirecting if the request includes a URL having a modified prefix.

According to another aspect of the present invention, a system for use in responding to a request for information, the system comprising: a server, associated with a domain, for receiving a request for information, the server including means for redirecting if the request includes a URL having a modified prefix.

According to another aspect of the present invention, a product comprising: a computer readable media; and information stored on the computer readable media to cause a computer to carry out a method, the method comprising: receiving a request for information from a requestor via the internet; and performing a processing step conditioned on the request having a URL including a modified prefix, a domain, and a suffix specified in the message provided by a non-internet media source.

According to another aspect of the present invention, a product comprising: a computer readable media; and information stored on the computer readable media to cause a computer to carry out a method, the method comprising: receiving, at a first server associated with a first domain, a request for information, the request including a URL having a modified prefix, a domain, and a suffix; and redirecting to a server for another domain based at least on the modified prefix.

According to another aspect of the present invention, a product comprising: a computer readable media; and information stored on the computer readable media to cause a computer to carry out a method, the method comprising: receiving a request for information from a requester via the internet, the request having a URL including a modified prefix, a domain, and a suffix specified in the message provided by a non-internet media source.

### BRIEF DESCRIPTION OF THE DRAWINGS

FIG. 1 is a representation of a typical content delivery system that employs a public network such as the Internet; and

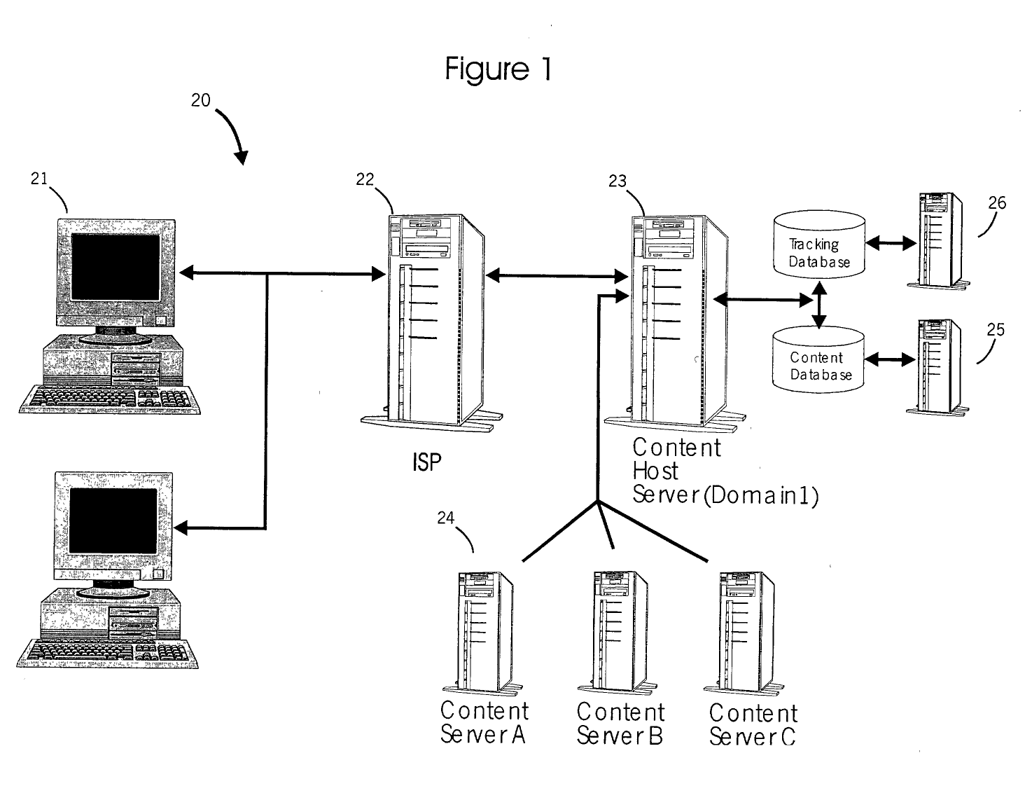

FIG. 2 shows a basic frame configuration on a terminal display.; and

FIG. 3 shows how the content from Content Servers A 36, B 37 and C 38 is supplied to the terminal 34 through the ISP 35; and

FIG. 4 demonstrates the standard configuration of the URL; and

FIG. 5 shows a process for supplying information according to one embodiment of the present invention; and

FIG. 6 shows one embodiment of a system for implementing the process described with respect to FIG. 5; and

FIG. 7 illustrates another embodiment of the invention; and

FIG. 8 demonstrates the logic process established by the combination of source knowledge and request data to develop immediate inferences in the immediacy of an online session; and

FIG. 9 illustrates another embodiment of the prefixed intermediary frame technique consisting of the use of a third party server 81 to redirect the respondent to the intermediary frame set; and

FIG. 10 represents a currently preferred implementation of the prefixed, intermediary frames-based marketing technique.

### DETAILED DESCRIPTION

This is a detailed description of a technique herein described as the prefixed, intermediary frame technique.

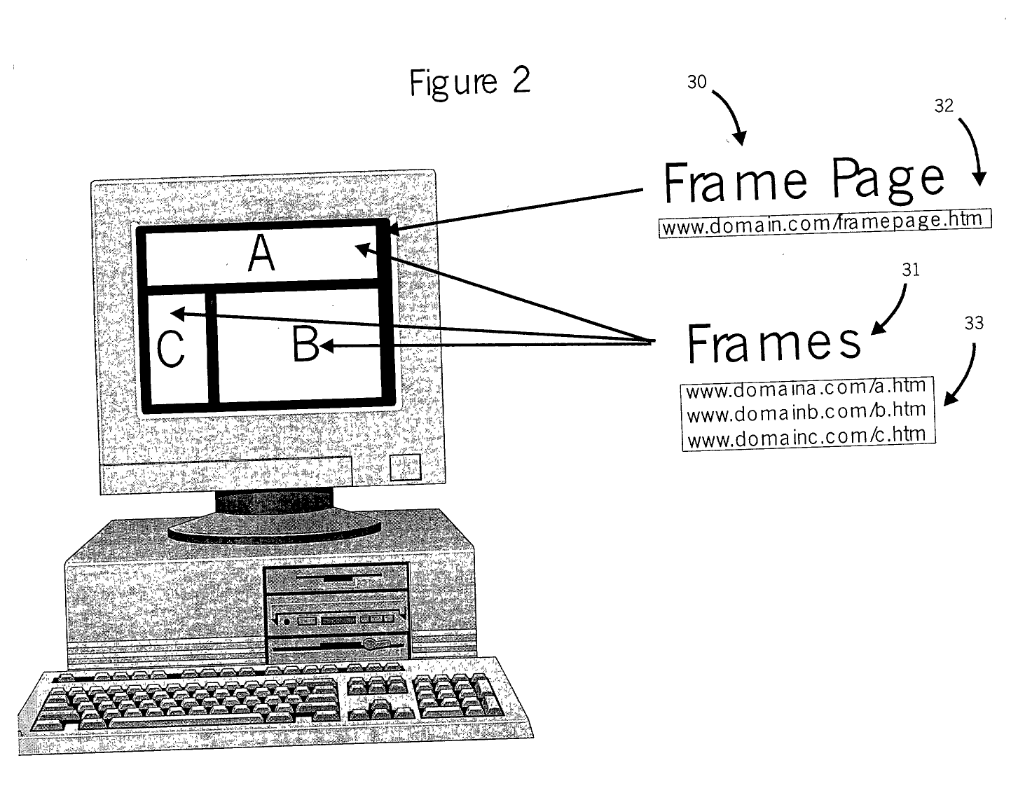

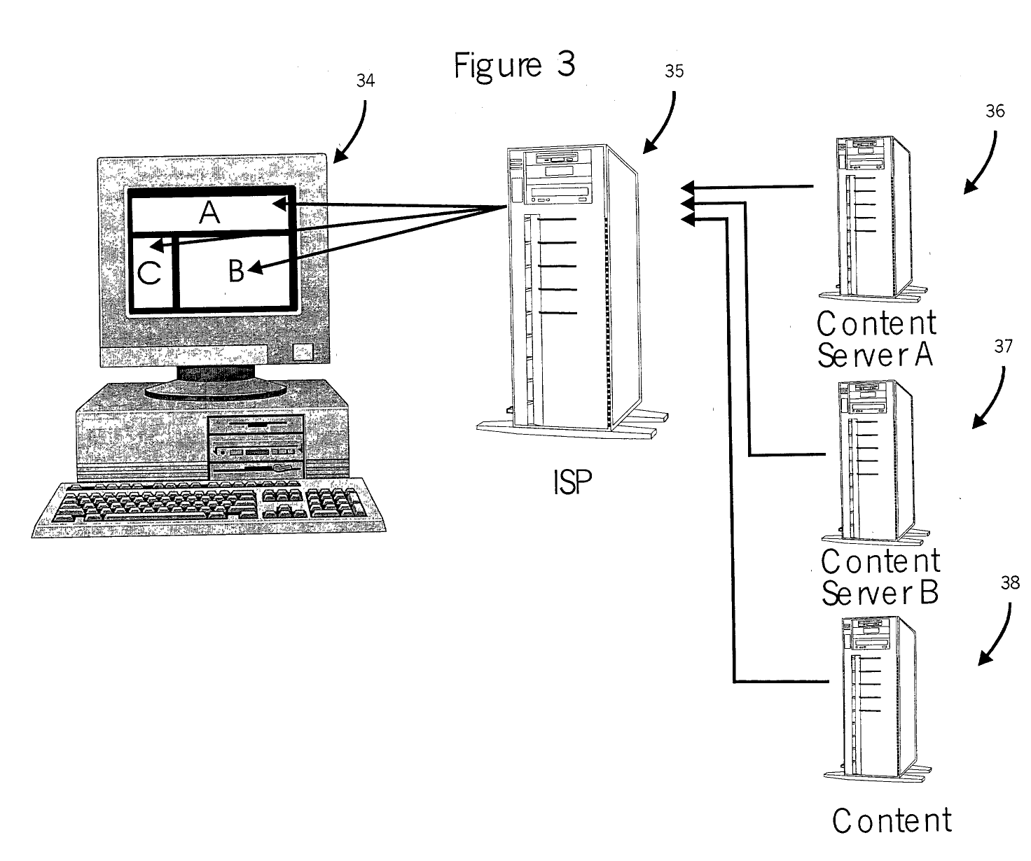

FIG. 2 shows a basic frame configuration on a terminal display. This includes a frame page 30, and the frames 31. The frame page designates the characteristics of the frames 31 to be presented in the user interface (for example, the dimension, the number, the layout, and other characteristics). The frames 31 present content from individual content sources. The frame content can be stored on the local server, or on other content providing servers. The frame page 30 also designates the content to be supplied, and the frame on which the content is to appear. Frame page 30 content is requested from an ISP (for example, ISP 35 (FIG. 3)) with the use of a URL 32 (universal resource locator, or nternet address) for the frame page. Individual URLs 33 for the content designated to appear in the frames are stored in the frame page code. The URLs 33 that define the content in a frame set (i.e., frame page and frames), request that the ISP supply content for each frame within the frame page 30 (e.g., Frames A, B & C). The frame page 30 can cause content within one or more of the frames to interact with other content within one or more of the frames.

FIG. 3 shows how the content from Content Servers A 36, B 37 and C 38 is supplied to the terminal 34 through the ISP 35, on the basis of specific programming language (Hypertext Markup Language, or HTML) within the frame page code (not shown). This content then appears in frames A, B & C on the terminal display.

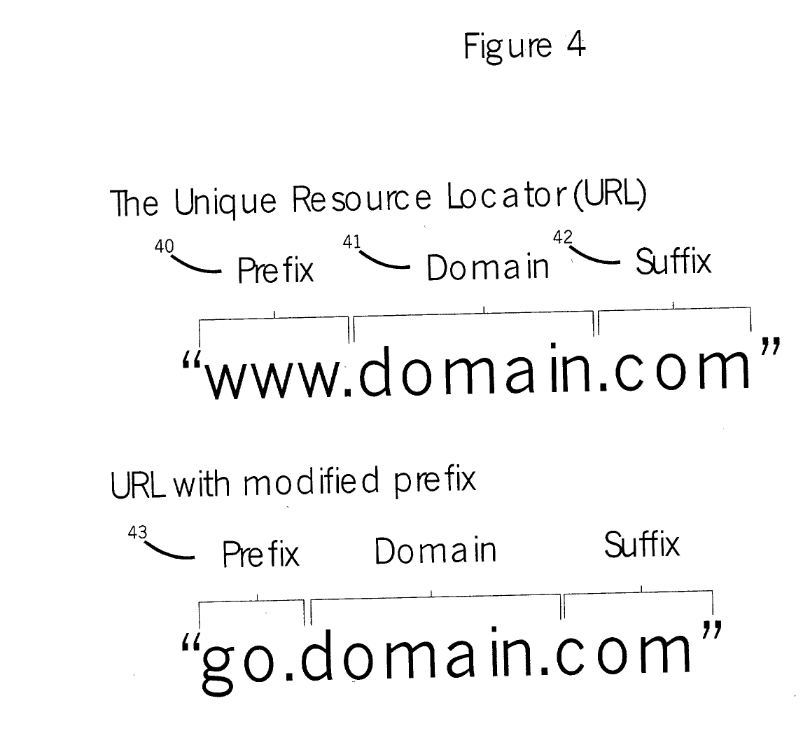

FIG. 4 demonstrates the standard configuration of the URL. The standard configuration includes three basic elements, the prefix 40, the domain name 41, and the suffix 42. The standard prefix for a World Wide Web location is “www,” although the use of a prefix 40 is not required. The domain name 41 and the suffix 42 identify the supplier of online content, such as the supplier of the frame page 30 (FIG. 2). An example of a domain name/suffix combination would be “Amazon.com.” The suffix is used in conjunction with the domain name.

Some embodiments of some aspects of the present invention employ a URL with a modified prefix. FIG. 4 shows a URL having a modified prefix 43. The modified prefix 43 is an alphanumeric substitute to the standard “www” prefix.

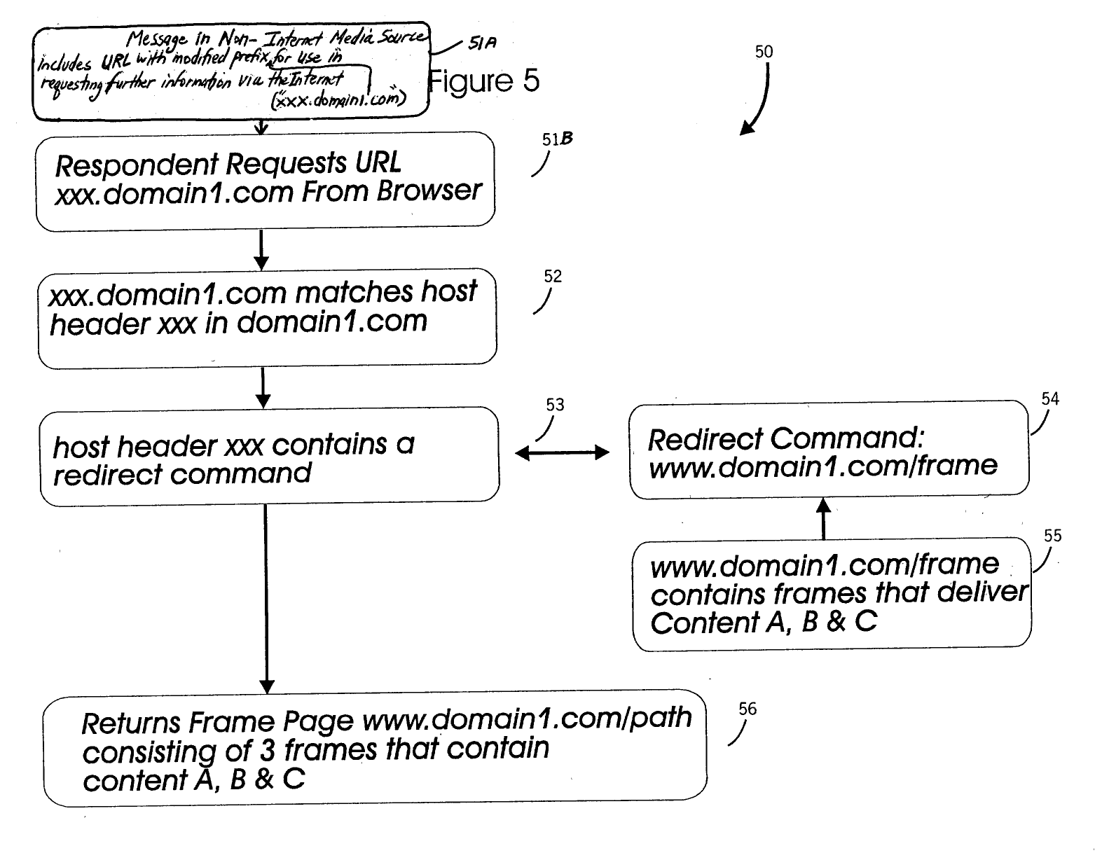

FIG. 5 shows a process for supplying information according to one embodiment of the present invention. The process is used in association with a message supplied by a non-internet media source 51a. Examples of such messages include advertising or editorial, either in print or broadcast media. The message includes a URL including a modified prefix, a domain, and a suffix (“xxx.domain1.com”). The reader or viewer of that message uses that URL to request information via the Internet, and one embodiment for processing the request is set forth in steps 51b-56, described hereinafter. At a step 51b, this URL is sent as a request by a respondent via the Internet to the content server. At a step 52, the modified URL matches an alphanumeric string on the server that is hosting the domain. This matching string is known as a host header, and forms part of a record set stored on the content server that also includes a redirect string 53 which supplies the respondent with specific content designated within the host header record that corresponds to the modified prefix 54, 55. When a request is made using the modified URL, the content server hosting the desired content delivers that content based on the redirect string associated with the matching host header 56.

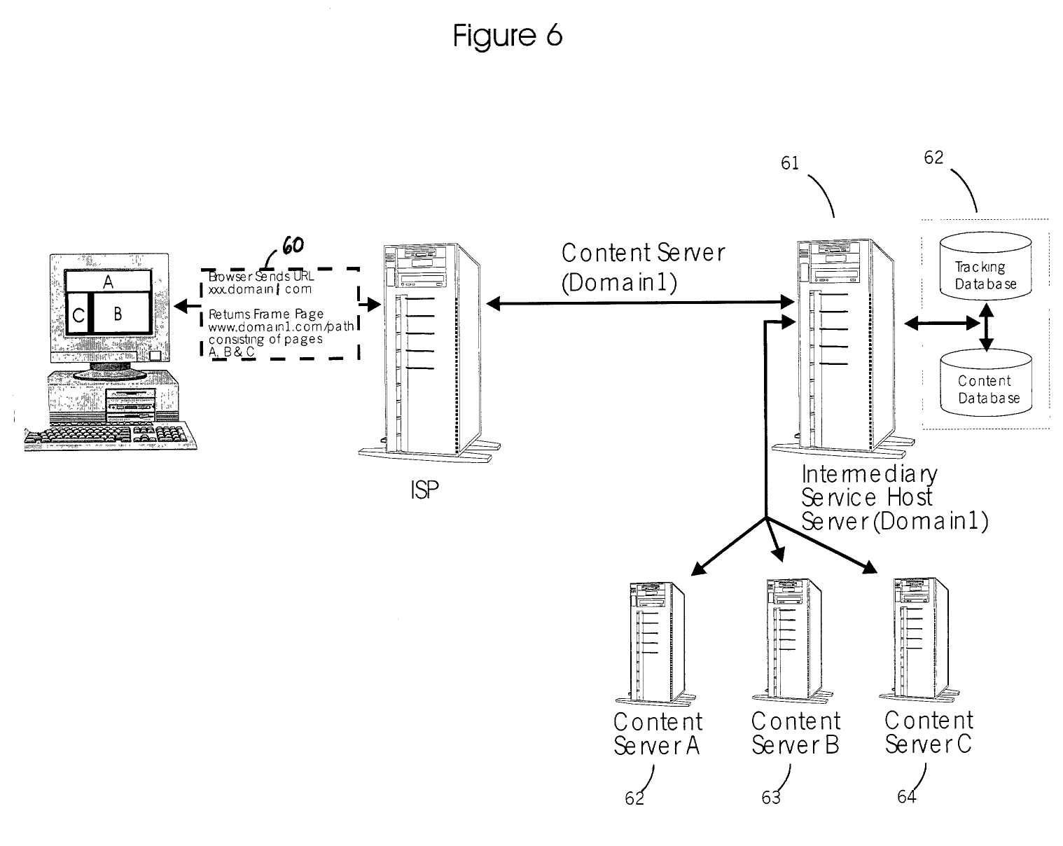

FIG. 6 shows one embodiment of a system for implementing the process described with respect to FIG. 5. In this embodiment, the browser sends a request (“xxx.domain1.com”) to the content server via an ISP. The content server then returns a frame page (“www.domain1.com/path”) consisting of pages A, B & C. The frame set's content is delivered by one content server 61 on the basis of one content delivery system 62. The content of the frames it delivers originates either from its own stored memory, from content stored on other content servers 63, 64, 65, or a combination of the two. This makes the content server that delivers the frame page, as well as the content, or frame page itself, intermediary between the respondent, and the content delivered in its frames. A URL including a modified prefix is submitted by a terminal operator in response to non-Internet content. The URL requests a frame set from the intermediary content provider 51b-56 (FIG. 5). That frame set is provided based on a redirect stored in the intermediary content provider's host server's memory 61. This redirect is contained in the same record that contains the host header that matches the unique prefix in the URL used by the terminal operator 51a (FIG. 5). The frame content matches the expectation of the respondent, as promised in the non-Internet content (advertisement, editorial, etc.), while the frame page—invisible to the respondent—allows the intermediary content provider to apply tracking and identification techniques from behind the scenes. This operation, in connection with the marketing method described here, is referred to herein as the “Invisible Frame.” Some additional uses for the system described above are as follows: First, it delivers expected content to the requestor without requiring the complex processing required to interpret the requestor's interests. Within a reasonable margin of error, those interests are inherent in the relationship of the published content to the respondent's online request. The unique URL published with the content of the non-Internet material is directly connected to the content delivered in the frame set via the host header. Thus, the directness of the connection established by this method between the non-Internet content and the Internet content provides the Internet content provider with a substantial new sense of the requester's interests within the immediacy of the session. The information inferring the respondent's interests as a function of the content and the non-media source that has produced the inquiry is known as “source data.” Source data also establishes that the content responded to, and the media in which it appears, combine to establish to a high degree of probability certain additional characteristics of the respondent, including those related to the demographic appeal of the media source. The immediate possession of source data by the internet content provider creates the opportunity of establishing a service intimacy that current content delivery methods may not achieve in the same amount of time. This intimate relationship can provide additional service opportunities for the content provider because establishing source data in connection with a record of the respondent's online request activity can add additional levels of inference about the respondent in the immediacy of the session. By processing a request from a respondent using the URL with the modified prefix, a web site can now relate source data to an additional record set that tracks the respondent's subsequent requests. Combining source data with request data, the site can infer to a greater degree of certainty, in the immediacy of that one session, what the respondent's interests are. It can, within the same session, make specific, automated support proposals based on this. It can rapidly add to its base of content delivery data. This is referred to herein as “sensitivity,” and provides a base for what is herein referred to as “recognition” of a known visitor in future sessions. Notwithstanding the benefit of the uses above, it should be recognized that they are not essential elements of the present invention.

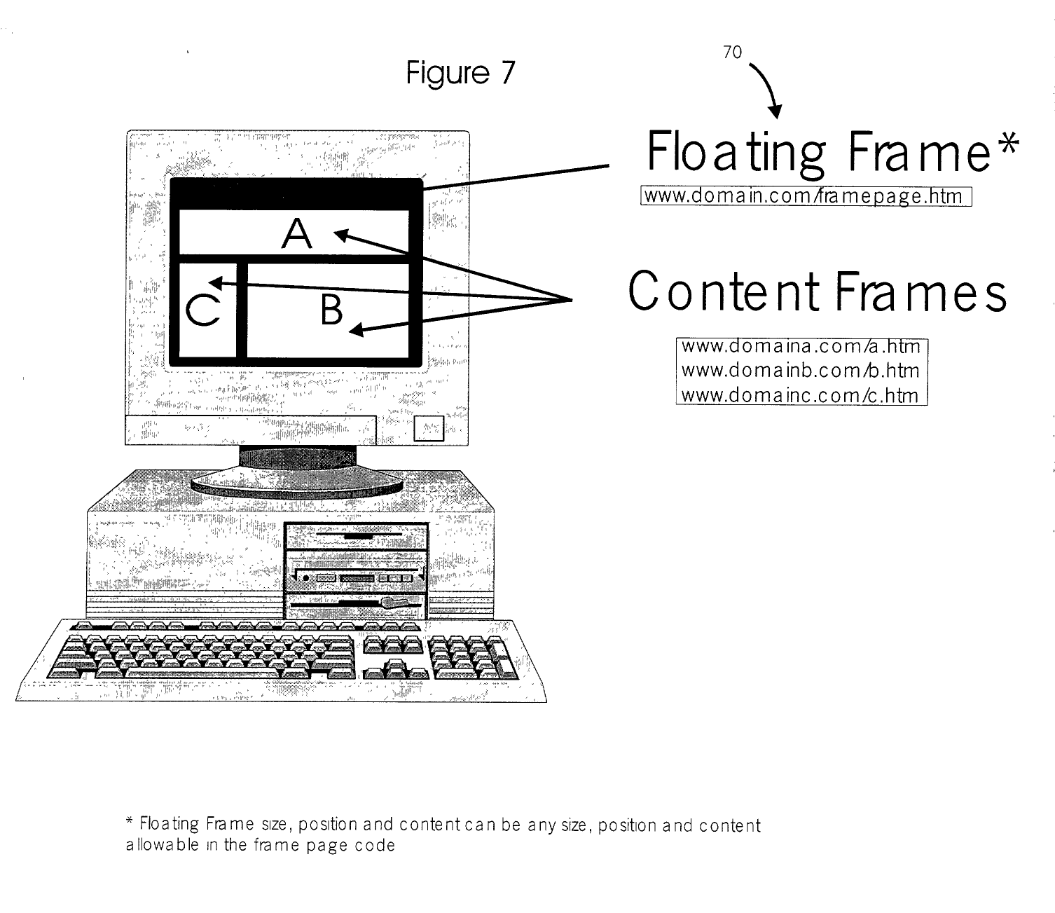

FIG. 7 illustrates another embodiment of the invention. This embodiment is referred to herein as the “Floating Frame” 70. While the Invisible Frame as described above uses the frame page to provide an intermediary between the user and requested online content, the Floating Frame makes use of the advantage obtained by the Invisible Frame in mediating the requested online content and the respondent making that request. The Floating Frame consists of an Invisible Frame, as described above, and adds additional content locally from the host server in the form of an additional frame or set of frames. This additional frame or set of frames can interact with the frames already included in the Invisible Frame. It does so on the basis of the source data as defined above as it is supplied to the Invisible Frame through the host header via the host header's connection with the uniquely prefixed URL. Locally supplied content can consist of (but is not limited to) additional hyperlinks that activate services rendered within the framed content (search engines, web services, etc.), or that change the content of those frames. Other locally supplied content can include web services that are provided in connection with the pre-established character of the respondent's interests. This character is implied in the respondent's source data. A second form of the Floating Frame embodiment occurs when it becomes necessary to run script from a frame within the frame set, but not visibly reveal the content of that frame to the respondent. In this case, code in the frame page creates a frame, with a designated page, but the visible frame dimension is set to “0” so that the floating frame is not visible to the user, though it is still present in the frame set.

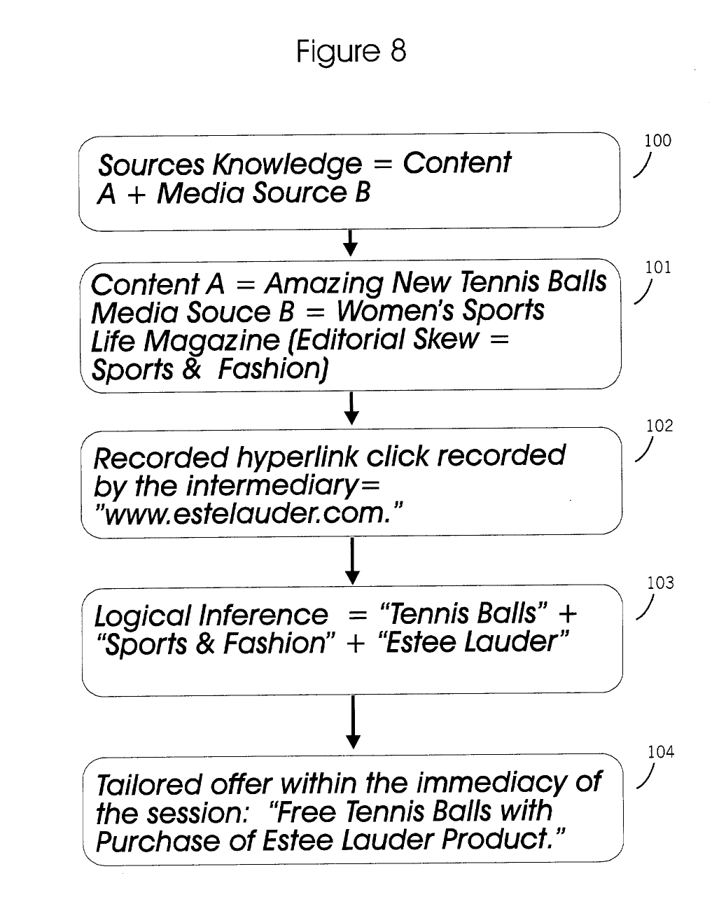

FIG. 8 shows one embodiment for combining source knowledge and request data to develop immediate inferences in the immediacy of an online session. It contemplates a scenario where a respondent to a particular advertisement in a particular magazine establishes source knowledge 100, 101. This source knowledge combines with request data 102, and allows the intermediary frame to draw an inference 103, and thereby supply additional, tailored content, such as a promotional offer 104, that has a certain probability of success.

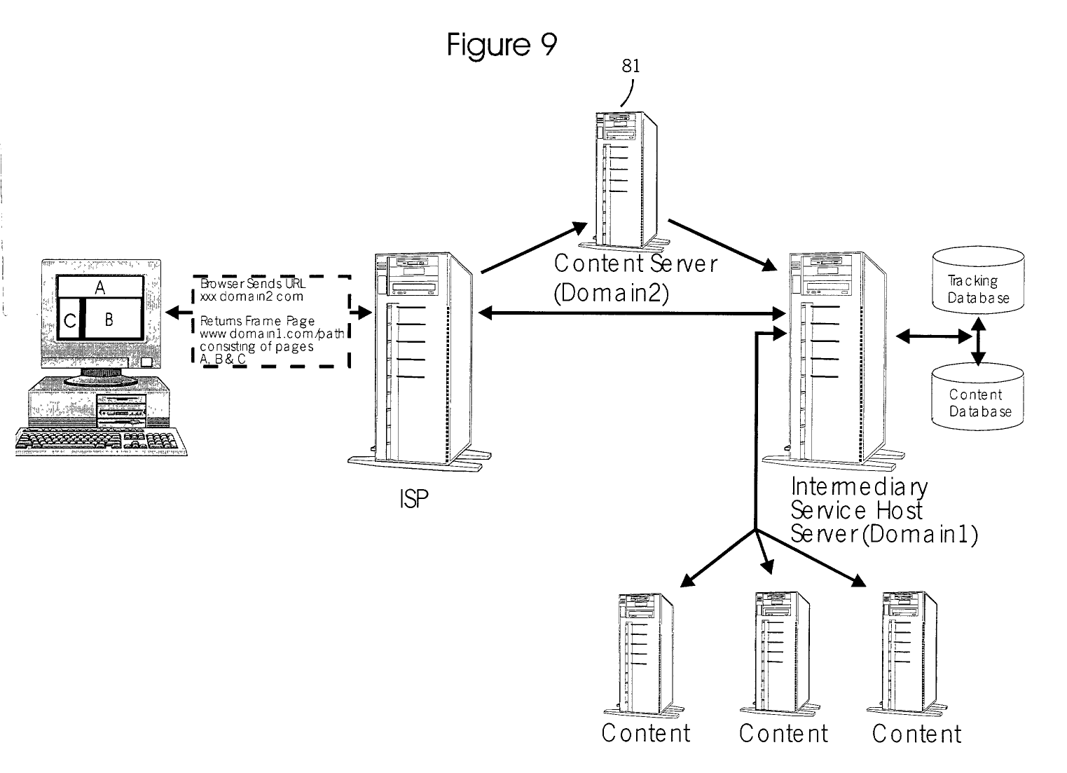

FIG. 9 illustrates another embodiment of the prefixed intermediary frame technique consisting of the use of a third party server 81 to redirect the respondent to the intermediary frame set. This server is used to secure the use of a particular domain name in the unique URL, at the discretion of the non-Internet content supplier. In this embodiment, the third party server becomes an element in the intermediary process.

Intermediary frames may be made using standard web-design methodology. They involve the implementation of a frame page with a unique URL (consisting of a prefix, a domain, and a suffix). That frame page contains within its code the description of the frames to be deployed in the respondent's browser, and the connection information for the content to be rendered in each frame. URLs with modified prefixes are determined by combining the domain that is to receive the respondent's requests with the prefix that the content provider decides to associate with specific content. Once such a determination is made, host headers are set up on the server hosting the domain to which the unique URL refers by entering text strings into a database stored on or connected to that server. These text strings match the unique URLs. Redirect information is then uniquely associated with each host header record. These redirects request that a particular content page be delivered to the respondent based on that respondent's use of the unique URL. The host headers reside on the server hosting the domain with which they are associated, and which is included in the URL published in the non-Internet content. In this embodiment, the associated redirects must request content from the intermediary frame page server. The intermediary server can make that request itself, in reference to material stored locally in its own memory.

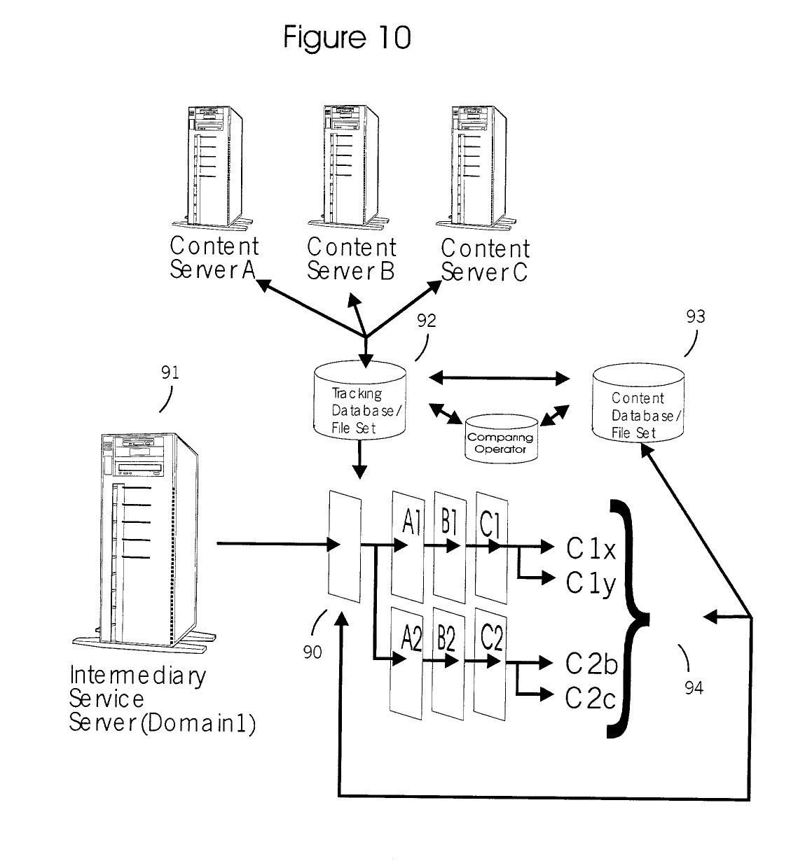

FIG. 10 represents a currently preferred implementation of the prefixed, intermediary frames-based marketing technique. This implementation consists of developing an intermediary system comprised of the intermediary content server 91, which includes host headers and redirects to deliver an intermediary frame 90, connected to a tracking database 92 which stores hit activity quantified by the frame set (i.e., source data and request data), and a content database 93 or file set which provides additional content or content requests by comparing source data and request data 94. A report structure is also set up consisting of web page data reports, and automated data transmission connections (DSN, email notifications, etc.) that report information to the content provider about respondent activities.

As Internet technology develops and spreads into broadband and portable applications, non-Internet media may play an increasing role in directing specific requests to online content providers. The manner in which online content providers receive and handle online inquiries will provide a competitive advantage. That manner is strongly affected by what the online content provider knows about the incoming respondent. The use of the intermediary technique will enable the online content provider to “recognize” the visitor by knowing the nature of the visit—that it is a response to something specific, and known in advance. This creates a new opportunity for online providers to establish new rules of polity—to demonstrate recognition in such a way as to develop a positive commercial relationship with the respondent in the immediacy of the session. When combined with knowledge gained through repeat visits by an automated content delivery system, this method can bring substantial understanding to the online provider in terms of what information will be most productive with respect to the response objectives of the provider. Moreover, the immediate nature of source data, when combined with request data and appended historical data, makes a clear contribution to applying artificial intelligence techniques to the online environment.

As used herein, and except where otherwise stated, the phrases “Message” and “Content” mean any type of information, and may or may not be publicly disseminated.

“Media source” or “media” can mean content provider, either Internet or Non-Internet based, or in other words, any organization providing publicly disseminated information, or the information products they produce.

“Non-Internet Media Source” or “Non-Internet Media” means i. any organization delivering content, or ii. any product of such an organization delivered, or publicly disseminated through any means that is not the Internet.

“ISP” stands for Internet Service Provider, which refers to an organization that provides public and private access to the Internet through content servers, and which also hosts internet content in registered domains, and provides that content on a limited or unlimited basis on request.

“Content Server” refers in this document to a computer that serves to deliver content provided by Internet web sites to terminal operators upon requests using a URL.

The term “URL” includes but is not limited to a text string consisting of a prefix, a domain name, and a suffix, each separated by a period, or dot (“.”). Note that in some embodiments, the URL may be associated uniquely with the media source only, or it may only be associated uniquely with the message, or it may be uniquely associated to both.

“Prefix” means the text string that precedes the domain name in the URL. The common prefix of world wide web sites is “www”.

“Modified prefix” means a prefix in a URL other than “www”, which may include alpha-numeric representations, and/or may include one or more symbols—for example period(s), comma(s), ampersand(s), and combinations thereof.

The term “request,” used in connection with the terms “URL,” “Prefix,” and “Modified Prefix” refers to the process whereby a command either entered into the address line of a browser, that is processed by Internet servers in order to deliver specific content to the requester. It also refers to a similar process that occurs when a hyperlink is clicked on.

“Source Data” refers to the specific facts that inhere to a request made by a respondent to content using a URL with a modified prefix when that prefix causes a redirect to an intermediary web page (i.e., that the inquiry can only have come via that specific content, or have been provided in that specific media product).

The term “intermediary” refers to the position occupied by a web page, and/or its provider, when it is requested by a URL that contains a modified prefix that either redirects the respondent to additional online content, or renders that content in a frame.

By “broadcast” is meant any type of broadcast over any type of communication link and communication medium for example but not limited radio, tv, cable tv. The broadcast may be digital or non-digital.

By “print” is meant visual representation on physical media such as paper, plastic, wood, sheet metal, or other suitable material, and including such publishing techniques as magazines, newspapers, books, public signage, premium products (pens, magnets, gift items, etc.), stationery, and all other techniques that similarly relate to the visual representation of information or content.

“Website” means Internet content supplied via a registered domain by an Internet content provider typically comprising a server associated with a domain name, and a file system stored on that server that is exclusively linked to that domain.

Also note that, except where otherwise stated, terms such as, for example, “comprises”, “has”, “includes”, and all forms thereof, are considered open-ended, so as not to preclude additional elements and/or features.

While there have been shown and described various embodiments, it will be understood by those skilled in the art that the present invention is not limited to such embodiments, which are presented by way of example only, and that various changes and modifications may be made without departing from the spirit and scope of the invention. Accordingly, the invention is limited only by the appended claims and equivalents thereto.

I claim:

1. A method for use in supplying information sought in response to a message provided by a non-internet media source, the method comprising:
receiving a request for information from a requestor via the internet, the request having a URL including a modified prefix, a domain, and a suffix specified in the message provided by a non-internet media source.

2. The method of claim 1 further comprising specifying the URL included in the message provided by the non-internet media source, the URL having the modified prefix, the domain, and the suffix.

3. The method of claim 1 wherein receiving the request comprises receiving the request at a first server associated with the domain specified by the request, and wherein the processing step comprises using the prefix of the URL to redirect to a server for another domain.

4. The method of claim 1 wherein receiving the request comprises receiving the request at a first server associated with the domain specified by the request, and the processing step comprises redirecting to a second server for a second domain if the prefix of the URL of the request matches the prefix identifying at least one of the media source and the message.

5. The method of claim 1 wherein the media source is not computer based.

6. The method of claim 1 wherein the media source comprises a print based media source.

7. The method of claim 1 wherein the media source comprises a broadcast based media source.

8. The method of claim 1 further comprising storing information regarding a source of the request and information regarding request activity.

9. A method for use in supplying information sought in response to a message provided by a non-internet media source, the method comprising:
receiving a request for information from a requestor via the internet; and
performing a processing step conditioned on the request having a URL including a modified prefix, a domain, and a suffix specified in the message provided by a non-internet media source.

10. The method of claim 9, wherein the processing step comprises redirecting.

11. The method of claim 9, wherein the processing step comprises automatically redirecting to content on the host server, or to content on another server.

12. The method of claim 9, wherein the processing step comprises redirecting to an intermediary frame that is dedicated to handling the request having the specified URL.

13. The method of claim 9, wherein the processing step comprises performing a redirect in response to receiving a request having the URL with the modified prefix matching a host header on the domain host, and causing a redirect to specified content.

14. The method of claim 9 further comprising specifying the URL included in the message provided by the non-internet media source, the URL having the modified prefix, the domain, and the suffix.

15. The method of claim 14 wherein specifying a URL comprises specifying a URL that is uniquely associated with either the non-internet media source or the message, or both the media source and the message.

16. The method of claim 14 wherein specifying a URL comprises specifying a URL having a modified prefix that is uniquely associated with the non-internet media source.

17. The method of claim 14 wherein specifying a URL comprises specifying a URL having a modified prefix that may be uniquely associated with the message.

18. The method of claim 9 wherein receiving the request comprises receiving the request at a first server associated with the domain specified by the request, and wherein the processing step comprises using the prefix of the URL to redirect to a server for another domain.

19. The method of claim 9 wherein receiving the request comprises receiving the request at a first server associated with the domain specified by the request, and the processing step comprises redirecting to a second server for a second domain if the prefix of the URL of the request matches the prefix identifying at least one of the media source and the message.

20. The method of claim 14 wherein specifying a URL comprises specifying a URL having a modified prefix that is associated with either the media source or the message.

21. The method of claim 9 wherein the media source is not computer based.

22. The method of claim 9 wherein the media source comprises a print based media source.

23. The method of claim 9 wherein the media source comprises a broadcast based media source.

24. The method of claim 9 wherein the processing step comprises updating statistical information associated with requests having the modified prefix in the URL.

25. The method of claim 24 wherein updating statistical information comprises updating statistical information associated with the number of requests having the modified prefix in the URL.

26. The method of claim 25 wherein updating statistical information comprises modifying a counter indicating the number of requests having the URL.

27. The method of claim 25 wherein updating statistical information comprises modifying records in a database to include a history of requests made in the session.

28. The method of claim 25 wherein updating statistical information comprises comparing statistical information supplied to a database with “source data” (as defined above).

29. The method of claim 9 wherein the processing step comprises supplying information to the requestor via the internet, the information being selected based at least in part on the prefix of the URL of the request.

30. The method of claim 9 wherein the processing step comprises supplying a first information content if the request includes a specific modified prefix in the URL, and supplying different information content if the request does includes a different modified prefix in the URL.

31. The method of claim 9 further comprising storing information regarding a source of the request and information regarding request activity.

32. The method of claim 31 wherein storing information regarding request activity comprises storing information regarding at least one of content requested and content supplied.

33. The method of claim 9 wherein the processing step comprises supplying content based on demographics associated with reader/viewer demographics of the non-Internet media source.

34. A method for use in responding to a request for information, the method comprising: receiving, at a first server associated with a first domain, a request for information, the request including a URL having a modified prefix, a domain, and a suffix; and redirecting to a server for another domain based at least on the modified prefix.

35. A method for use in supplying information sought by a consumer of goods or services in response to a message provided by a non-internet media source in regard to a supplier or goods or services, the method comprising:
specifying a predetermined URL to be included in the message to be provided by the non-internet media source, the predetermined URL having a modified prefix, a domain, and a suffix; and
servicing a request for information regarding the supplier or goods or services supplied by the supplier, through a website that is associated with the predetermined URL.

36. The method of claim 35 wherein the servicing of a request comprises servicing a request for information regarding the supplier or goods or services supplied by the supplier through a non-supplier operated, intermediary website that is linked to the supplier's web site through redirects that are implemented in cooperation between the supplier and the non-supplier.

37. The method of claim 35 wherein servicing a request comprises supplying information in response to the request, the information being based at least in part either on demographics associated with readers of the non-internet media source, or on the non-Internet content.

38. The method of claim 35 wherein the servicing of a request comprises servicing a request for information regarding the supplier or goods or services supplied by the supplier through a non-supplier operated, intermediary website.

39. The method of claim 35 further comprising supplying statistical information to at least one of the supplier, the media source, and a developer of the message.

40. The method of claim 39 wherein the statistical information includes information that indicates at least one of a count of the requests having the predetermined URL and a frequency of the requests having the predetermined URL.

41. The method of claim 39 wherein the statistical information includes information that indicates an amount, sequence and duration of additional requests made through content delivered in response to the request.

42. The method of claim 35 further comprising gathering qualitative information.

43. The method of claim 35 wherein servicing the request comprises using frame pages hosted on a website to mediaterequests.

44. A system for use in supplying information sought in response to a message provided by a non-internet media source, the system comprising:
a server for receiving a request for information from a requester via the internet, and for performing a processing step conditioned on the request having a URL including a modified prefix, a domain, and a suffix specified in the message provided by a non-internet media source.

45. A system for use in supplying information sought in response to a message provided by a non-internet media source, the system comprising:
a server for receiving a request for information from a requestor via the internet, the server including means for performing a processing step conditioned on the request having a URL including a modified prefix, a domain, and a suffix specified in the message provided by a non-internet media source.

46. A system for use in responding to a request for information, the system comprising:
a server, associated with a domain, for receiving a request for information, and for redirecting if the request includes a URL having a modified prefix.

47. A system for use in responding to a request for information, the system comprising:
a server, associated with a domain, for receiving a request for information, the server including means for redirecting if the request includes a URL having a modified prefix.

48. A product comprising:
a computer readable media; and
information stored on the computer readable media to cause a computer to carry out a method, the method comprising:
receiving a request for information from a requestor via the internet; and
performing a processing step conditioned on the request having a URL including a modified prefix, a domain, and a suffix specified in the message provided by a non-internet media source.

49. A product comprising:
a computer readable media; and
information stored on the computer readable media to cause a computer to carry out a method, the method comprising:
receiving, at a first server associated with a first domain, a request for information, the request including a URL having a modified prefix, a domain, and a suffix; and
redirecting to a server for another domain based at least on the modified prefix.

50. A product comprising:
a computer readable media; and
information stored on the computer readable media to cause a computer to carry out a method, the method comprising:
receiving a request for information from a requester via the internet, the request having a URL including a modified prefix, a domain, and a suffix specified in the message provided by a non-internet media source.
